(19) United States
(12) Patent Application Publication
(10) Pub. No.: US 2009/0147138 A1
(43) Pub. Date: Jun. 11, 2009

(54) Multi-View Display System and Method with Synchronized Views

(76) Inventor: George William Pawlowski, Plano, TX (US)

Correspondence Address: TEXAS INSTRUMENTS INCORPORATED, P O BOX 655474, M/S 3999, DALLAS, TX, 75265, US

(21) Appl. No.: 11/952,854

(22) Filed: Dec. 7, 2007

(51) Int. Cl. H04N 5/445

(52) U.S. Cl. 348/564; 348/E05.099

(57) ABSTRACT

System and method for operating a multi-view display system. An embodiment method includes receiving an image frame comprising a first portion and a second portion; displaying a first image on a display panel during a first display period, wherein the first image includes the first portion of the image frame, and wherein the second portion of the image frame is masked in the first image; and after displaying the first image, displaying a second image on the display panel during a second display period. The first image includes the second portion of the image frame, and the first portion of the image frame is masked in the second image. The first portion and the second portion of the image frame are displayed in different areas of the display panel.

### TECHNICAL FIELD

The present application relates generally to systems and methods for video games, and more particularly to systems and methods for multi-player mode display.

### BACKGROUND

Video games may be played in single-player mode or multi-player mode. In single-player mode, the player may play a solo game or against the game console, and thus only one display screen may be needed. The displayed view will thus be the player's view. In the multi-player mode, multiple players at the same location often share a common screen (display panel). In this case, the multiple players typically have the same view.

In some video games, the multiple players play against each other, and hence each player has a different view from others. Existing game consoles provide support for two players to play using a same screen by splitting the screen into a top portion and a bottom portion, with the top portion displaying one player's view, and the bottom portion displaying the other player's view. Some newer systems with wide aspect-ratio outputs are now supporting splitting the screen into a left portion and a right portion, each displaying one of the players' views.

The above-discussed dual-player display schemes, however, suffer from drawbacks. Since both players' views are displayed on a same screen, each player can see his own view and the opponent's view. This allows players to gain advantage by looking at the opponent's view. Accordingly, a strong player may become even stronger. In addition, the conventional display schemes may result in some of the fun part being taken out of the game, that is, the decision-making without knowing the opponent's actions.

One of the solutions for solving the above-discussed problems is to overlay two full-screen views of both players on a same screen, wherein the views of the two players are displayed alternatively. Each player needs to wear goggles, each being synchronized with one of the displayed views while the other's view is blocked by the goggles. A drawback of this solution is that for observers not wearing goggles, both players' views are overlayed. Therefore, the views received by the observers are unlikely to make any sense. This solution also requires the game console to double its standard output rate to output two full-screen images for both players' views. The display device must also support this higher input rate. There must also be a method for synchronizing the console output to the display and the glasses. It is likely that most existing game consoles cannot support this method.

### SUMMARY OF THE APPLICATION

These and other problems are generally solved or circumvented, and technical advantages are generally achieved, by embodiments of the present application which provide a system and a method for synchronizing goggles and display systems.

In accordance with an embodiment, a method for operating a multi-view display system includes receiving an image frame comprising a first portion and a second portion; displaying a first image on a display panel during a first display period, wherein the first image includes the first portion of the image frame, and wherein the second portion of the image frame is masked in the first image; and after displaying the first image, displaying a second image on the display panel during a second display period. The first image includes the second portion of the image frame, and wherein the first portion of the image frame is masked in the second image, and wherein the first portion and the second portion of the image frame are displayed in different areas of the display panel. The method further includes providing viewing devices for allowing a video game player to see only one of the first and the second images.

In accordance with another embodiment, a method for operating a multi-view display system includes receiving a plurality of image frames, wherein the plurality of image frames have a first interval between two consecutive image frames, and wherein each of the plurality of image frames includes a first portion and a second portion corresponding to a first area and a second area of a display panel, respectively. The method further includes, for each of the plurality of image frames, generating a first sub image frame including the first portion of the respective image frame corresponding to the first area of the display panel, wherein the second area of the display panel is masked in the first sub image frame; generating a second sub image frame including the second portion of the respective image frame corresponding to the second area of the display panel, wherein the first area of the display panel is masked in the second sub image frame; and displaying the first and the second sub image frames on the display panel with a second interval therebetween, wherein the second interval equals to a half of the first interval. The method further includes providing synchronization signals corresponding to time points for displaying the first and the second sub image frames; and providing a first and a second viewing device in response to the synchronization signals. The first viewing device allows viewing of the first sub image frame and blocks viewing of the second sub image frame. The second view device allows viewing of the second sub image frame and blocks viewing of the first sub image frame.

In accordance with yet another embodiment, a method for operating a multi-view display system includes receiving an image frame including a first portion and a second portion; generating a first image including the first portion of the image frame, wherein the second portion of the image frame is masked in the first image; and generating a second image including the second portion of the image frame, wherein the first portion of the image frame is masked in the second image. The first portion and the second portion of the image frame are corresponding to different areas of the display panel.

In accordance with yet another embodiment, a display system includes a display panel and a controller. The controller is electrically coupled to the display panel and is configured to receive an input image frame; to display a first image on the display panel during a first display period, wherein the first image includes a first portion of the input image frame, and wherein a second portion of the input image frame is masked in the first image; and after displaying the first image, to display a second image on the display panel during a second display period, wherein the second image includes the second portion of the input image frame, wherein the first portion of the input image frame is masked in the second image, and wherein the first and the second portions of the input image frames are displayed in different areas of the display panel. The controller is further configured to generate synchronization signals corresponding to the first and the second display periods.

In accordance with yet another embodiment, a display system includes a light source; an array of light modulators optically coupled to the light source, the array of light modulators configured to produce images on a display panel by modulating light from the light source based on image data; and a controller electronically coupled to the array of light modulators and to the light source. The controller configured to receive an input image frame; display a first image on the display panel during a first display period, wherein the first image includes a first portion of the input image frame, and wherein a second portion of the input image frame is masked in the first image; and after display the first image, display a second image on the display panel during a second display period, wherein the second image includes the second portion of the input image frame, and wherein the first portion of the input image frame is masked in the second image, and wherein the first and the second portions of the input image frames are displayed in different areas of the display panel. The controller is further configured to generate synchronization signals corresponding to the first and the second display periods. The system further includes a signal dispatcher electrically coupled to the controller, and a first and a second viewing device signally coupled to the signal dispatcher and responsive to the synchronization signals. The signal dispatcher is configured to dispatch the synchronization signals. The first viewing device allows viewing of the first image and blocks viewing of the second image. The second view device allows viewing of the second image and blocks viewing of the first image.

An advantage of various embodiments is that each video game player may only see his own view, while observers may see views of all players. Also, various embodiments are compatible with existing gaming consoles.

The foregoing has outlined rather broadly the features and technical advantages of the present application in order that the detailed description of the present application that follows may be better understood. Additional features and advantages of the embodiments will be described hereinafter which form the subject of the claims of the present application. It should be appreciated by those skilled in the art that the conception and specific embodiments disclosed may be readily utilized as a basis for modifying or designing other structures or processes for carrying out the same purposes of the present application. It should also be realized by those skilled in the art that such equivalent constructions do not depart from the spirit and scope of the present application as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1 is a block diagram of a game display system;

FIG. 2 illustrates a block diagram of a projection display unit connected to a video game console;

FIG. 3 illustrates image frames of a dual-player game display system, wherein the views of two players are shown in a top area and a bottom area of a display panel;

FIG. 4 illustrates the states of goggles 1 and 2 used in the dual-player game display system;

FIG. 5 illustrates the interaction between the goggles and the display;

FIG. 6 illustrates image frames of a dual-player game display system, wherein images for the players are shown in a left area and a right area of a display panel;

FIG. 7 illustrates image frames of a quad-player game display system, wherein images for the players are shown in four different areas of a display panel;

FIG. 8 illustrates the states of goggles used in the quad-player game display system; and

FIG. 9 illustrates image frames of a quad-player game display system, wherein images for the players are shown in three different areas of a display panel, with a group of players sharing a common view.

### DETAILED DESCRIPTION OF ILLUSTRATIVE EMBODIMENTS

The making and using of the embodiments are discussed in detail below. It should be appreciated, however, that the present application provides many applicable inventive concepts that can be embodied in a wide variety of specific contexts. The specific embodiments discussed are merely illustrative of specific examples, and do not limit the scope of the present application.

The embodiments will be described in a specific context, namely a game display system. The embodiments may be applied to various display systems using different display mechanisms, such as projection display systems utilizing deformable micro-mirrors, transmissive and reflective liquid crystal, liquid crystal on silicon, and the like.

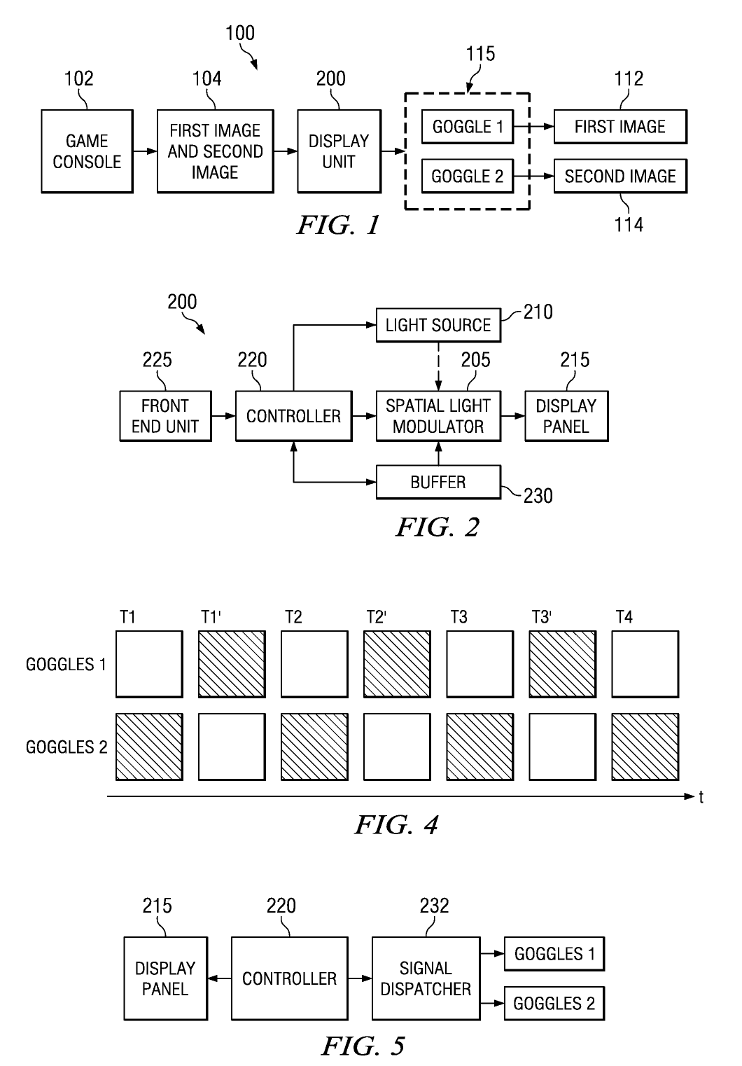

FIG. 1 schematically illustrates a block diagram of game display system 100. Game display system 100 includes display unit 200 that is used to display images, which may include a first image 112, which includes a view of a first player, and a second image 114, which includes a view of a second player. Although not illustrated, game display system 100 may display more images, each being a view of an additional player. First image 112 and second image 114 may be generated from game console 102, combined as single image 104, and output from game console 102 into display unit 200.

Viewer mechanisms 115, normally worn by a user in the form of eyeglasses or goggles, may separate the images. Viewer mechanisms 115 may separate images 112 and 114 that are optically displayed alternatively, and hence may block the view of one image while permitting the other image to be viewed. In the illustrated example, viewer mechanisms 115 include goggles 1 and goggles 2, each filtering one of first image 112 and second image 114, and allowing the respective players to see only one of these images.

With reference now to FIG. 2, there is shown a diagram illustrating an exemplary display unit 200, which is a projection display unit. In an embodiment, display unit 200 utilizes spatial light modulator 205, which may be an array of light modulators, wherein individual light modulators in the array of light modulators 205 assume a state corresponding to image data for an image being displayed by display unit 200. The array of light modulators 205 is preferably a digital micro-mirror device (DMD) with each light modulator being a positional micro-mirror. For example, in display units where the light modulators in the array of light modulators 205 are micro-mirror light modulators, the light from light source 210 may be reflected away from light modulators 205 and toward display panel 215. A combination of the reflected light from the light modulators in the array of light modulators 205 produces an image corresponding to the image data. In alternative embodiments, display unit 200 may include other types of displays using different mechanisms, such as liquid crystal display (LCD), cathode ray tube (CRT), or the like, providing their display rates may be adjusted as desired, as will be discussed in detail in subsequent paragraphs.

Controller 220 coordinates the loading of the image data into the array of light modulators 205, outputting light by light source 210, and so forth. Controller 220 may be coupled to front-end unit 225, which may be responsible for operations such as converting analog input signals into digital, Y/C separation, automatic chroma control, automatic color killer, and so forth, on an input video signal. Front-end unit 225 may then provide the processed video signal to controller 220. For example, when used as multi-view display system, front-end unit 225 may provide to controller 220 image data received from game console 102 (refer to FIG. 1). Controller 220 may be an application-specific integrated circuit (ASIC), a general-purpose processor, and the like, and may be used to control the general operation of the projection display unit 200. Buffer 230 may be used to store image data, sequence color data, and various other information used in the displaying of images.

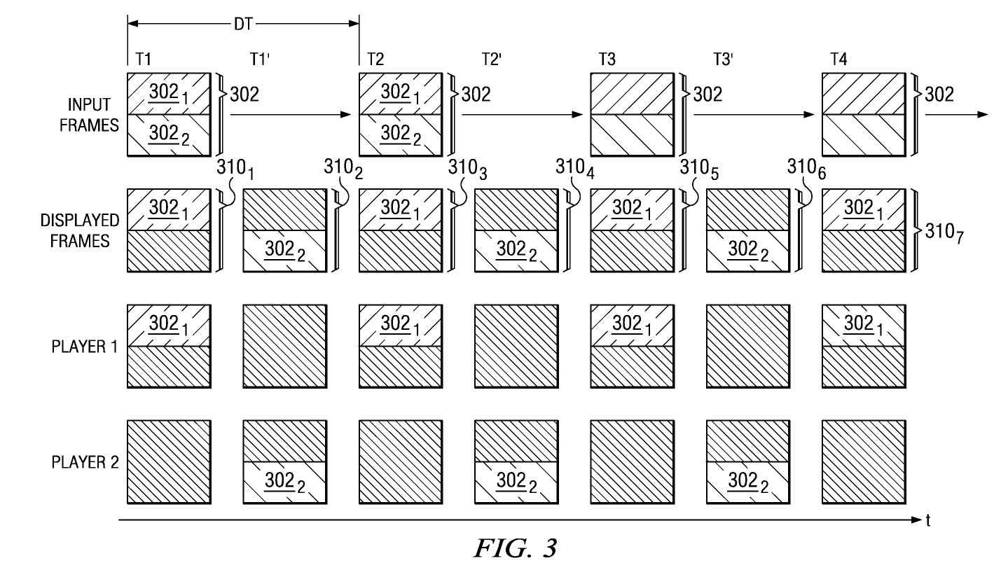

FIGS. 3 and 4 illustrate how display unit 200 interacts with viewer mechanism 115 (refer to FIG. 1) to generate desirable views for the players. In FIG. 3, the time sequence t is shown as from left to right. The first row of FIG. 3 illustrates input image frames 302 (also referred to as images throughout the description) received from game console 102. When time t elapses from T1 through T4, image frames 302 are received consecutively. Throughout the description, the frame rate of image frames 302 is indicated as Rf, which may be standard frame rates, such as 50 Hz or 60 Hz. Please note each of the image frames 302 occupies the entire frame time, which is symbolized by an arrow following each of the image frames 302. In an exemplary embodiment wherein the frame rate Rf is 60 Hz, the time interval DT (equals 1/Rf) between two consecutive image frames 302 is about 16.667 milliseconds. Each of image frames 302 includes top portion 302₁ and bottom portion 302₂, wherein top portion 302₁ includes the view of the first player and the bottom portion 302₂ includes the view of the second player. Throughout the description, when portions in an image frame are referred to, for example, a left portion and a right portion, these portions should not be construed as having different transmission order, even if a right portion may be illustrated as on the right side, and hence appears as later in time, than the left portion.

Input image frames 302 are processed by controller 220 (refer to FIG. 2) to generate new image frames 310, as is shown as the second row in FIG. 3. Image frames 310 are displayed on display panel 215 (refer to FIG. 2) in the sequence shown in FIG. 3, and preferably at a fixed rate, wherein the display is also controlled by controller 220. The frame rate Rfn of image frames 310 (hence the display rate of display panel 215 as in FIG. 2) is equal to at least twice, and may be more, the input image frame rate Rf. If more than two players are involved, Rfn may be equal to N* Rf, wherein N is an integer greater than 2, and indicates the number of views. For a 3-player mode, N is three.

The image frame 302 at time T1 is separated into two image frames 310₁ and 310₂, wherein image frame 310₁ is displayed at time T1, while image frame 310₂ is displayed at time T1′, which is preferably equal to T1+(T2−T1)/2. It is realized that although the display of image frame 310₁ is shown as at time T1, the same as the receiving time of the first image frame 310, in practical cases, due to the processing time, the display of image frame 310₁ and subsequent image frames 310 may actually be slightly delayed (typically a full frame time) from the receiving time of the respective image frames 302. For example, image frame 310₁ may be displayed at time T2, while image frame 310₂ is displayed at time T2′, which is preferably equal to T2+(T3−T2)/2. The frame rate Rfn of image frames 310 is doubled over the frame rate Rf of image frames 302.

Image frame 310₁ includes image portion 302₁ in its top area, with the remaining areas (the bottom area in this case) masked (preferably blackened). Image frame 310₂ includes image 302₂, preferably at the bottom area of image 310₂, with the remaining areas masked (or blackened). One skilled in the art will realize that image portions 302₁ and 302₂ do not have to be shown in the same areas as they are in images frames 302. For example, image portion 302₁ may be in the bottom area of image frame 310₁, while image portion 302₂ may be in the top area of image frame 310₂. The separation of image frames 302 is repeated for each of input image frames 302. For example, image frame 302 at time T2 is separated into two image frames 310₃ and 310₄, wherein image frame 310₃ is displayed at time T2, while image frame 310₄ is displayed at time T2+(T3−T2)/2. The boundaries between masked and un-masked portion in image frames 310 may be controlled using on-screen display (OSD) or remote control, so that the sizes of the first and the second portions of images 310 may be adjusted. Accordingly, if the lower boundary of image portion 302₁ in image 310₁ is lowered, the upper boundary of image portion 302₂ in image 310₂ is also lowered, and vice versa. Image portions 302₁ and 302₂ in images 310 will thus not overlap when they are displayed.

Preferably, the separation of the image frames is performed by a formatter, which may be a part of controller 220 (refer to FIG. 2). For each of image frames 310, a complete color display is required. Accordingly, in the DLP technology using a pulse width modulation (PWM) display technique: all bit weights should be displayed to ensure the display of complete images. In order to reduce the required bandwidth to spatial light modulator 205, it is preferable that only the un-masked portions of images 310 are loaded onto spatial light modulator 205, so that the pulse-width modulation (PWM) performance may be improved. The masked portions of the display can be loaded once to set the display to black or off.

The images displayed by display unit 200 may be viewed by players wearing viewer mechanisms 115 (refer to FIG. 1). Examples of viewer mechanisms 115 may be goggles, glasses, helmets with eyepieces, and so forth. Viewer mechanisms 115 may contain a sensor(s) for detecting the synchronization signals, as will be discussed in subsequent paragraphs. Viewer mechanisms 115 may utilize a variety of shutters to enable and disable the players from seeing the images displayed by the projection display unit 200. The shutters may be electronic, mechanical, liquid crystal, and so forth. An electronic shutter may block light or pass light, or based on a polarity of an electric potential applied change a polarity of an electronic polarizer. A liquid crystal shutter may operate in a similar manner, with the electric potential changing the orientation of liquid crystals. A mechanical shutter may block or pass light when a motor, for example, moves mechanical light blocks in and out of position.

FIG. 4 illustrates the states of exemplary goggles 1 and 2 in view mechanisms 115, wherein hollow rectangles represent an “on” state, during which the respective goggles are transparent, and blackened rectangles represent an “off” state, during which the respective goggles are opaque. Please note the time sequence t of FIG. 4 is aligned to the time sequence of FIG. 3. Referring to the first row of FIG. 4, at time T1, goggles 1 are at the “on” state, and hence allowing player 1 to view image frame 310₁ in FIG. 3. At time T1′, goggles 1 are at the “off” state, and hence blocking player 1 from viewing image frame 310₂ in FIG. 3. At times T2, T2′, T3, T3′, and so on, goggles 1 toggle between “on” and “off” states in a repeated pattern. Accordingly, goggles 1 only allow player 1 to view image frames 310 with odd-numbered subscripts. The view perceived by player 1 is illustrated as the third row in FIG. 3. As a result, player 1 will only see the image portions 302₁.

Referring to the second row in FIG. 4, at time T1, goggles 2 are at the “off” state, and hence blocking player 2 from viewing image frame 310₁ in FIG. 3. At time T1′, goggles 2 are at the “on” state, and hence allowing player 2 to view image frame 310₂ in FIG. 3. At times T2, T2′, T3, T3′, and so on, goggles 2 also toggle between “on” and “off” states in a repeated pattern. Accordingly, goggles 2 only allow player 2 to view image frames 310 with even-numbered subscripts. The view perceived by player 2 is illustrated as the fourth row in FIG. 3. As a result, player 2 will only see image portions 302₂.

It is preferred that the transition of the states of goggles 1 and 2 start at the same time, or after, the corresponding image frames 310 (refer to FIG. 3) have been displayed, so that no player will see even the residue of the other player's view, even if the view is faded.

The synchronization between display panel 215 (refer to FIG. 2) and view mechanisms 115 (refer to FIG. 1) may be implemented in various ways. An exemplary embodiment is shown in FIG. 5. Controller 220 may, in addition to the above-discussed functions, send synchronization signals to synchronize the operations of goggles 1 and goggles 2 with display panel 215.

The synchronization between display panel 215 and goggles 1 and 2 may be performed through wires, or performed wirelessly. In an exemplary embodiment, signal dispatcher 232 coupled to the controller 220 may emit infrared, ultrasonic, radio frequency, or some other form of signals to goggles 1 and 2. The signals dispatched by signal dispatcher 232 may convey timing information to goggles 1 and 2 to ensure that the synchronization with the displayed images is maintained. Signal dispatcher 232 may obtain timing information from controller 220, such as when controller 220 initiates the display of an image. Signal dispatcher 232 may then provide the timing information to the goggles 1 and 2. As a response, goggles 1 and 2 prevent the respective players from viewing the other player's view, for example, by closing an electronic shutter, thereby preventing the viewer from seeing the image being displayed.

Potentially more complex synchronization signals may be dispatched. For example, the synchronization signals may specify the shutter on-time duration, the time when the transitions should start, the operating mode of the display system (such as three-dimensional images or multi-view, for example), control data, information, and so forth. Furthermore, the synchronization signals may be encoded so that only viewer mechanisms 115 that are authorized will be able to process the information contained in the synchronization signals.

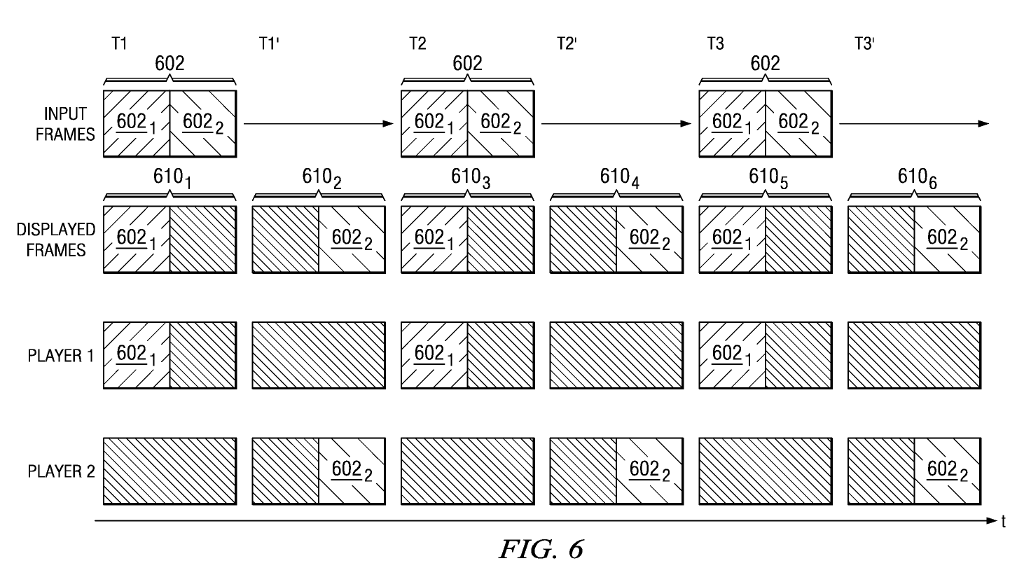

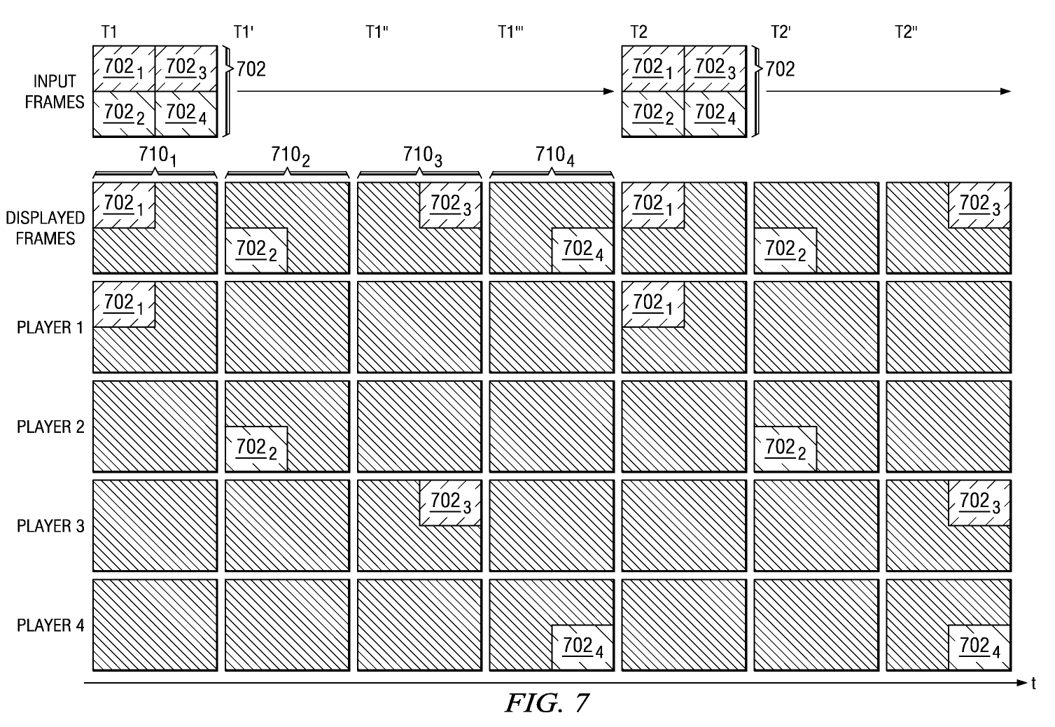

FIG. 6 illustrates an alternative embodiment. Instead of being divided into top portions and bottom portions, the input image frames may be divided into left portions and right portions, each for displaying a view for a player. The first row of FIG. 6 illustrates input image frames 602 received from the game console. Again, left portion 602₁ and right portion 602₂ are each for a player. The second row of FIG. 6 illustrates the images displayed on display panel 215. Similar to FIG. 3, each of image frames 602 are separated into two images 610, wherein image frames 610 with odd-numbered subscripts show views for the first player, and image frames 610 with even-numbered subscripts show views for the second player. Again, goggles 1 and 2 are synced with display panel 215, for example, using essentially the same mechanism as shown in FIG. 4. The views perceived by players 1 and 2 are shown in the third and the fourth rows of FIG. 6, respectively.

FIG. 7 illustrates yet another embodiment, wherein up to four players may play games using a common display panel, with each player having his/her own view. In an exemplary embodiment, each input image frame 702 is separated into four portions, left top portion 702₁, left bottom portion 702₂, right top portion 702₃, and right bottom portion 702₄. Each portion shows a view for a player. Correspondingly, each of the image frames 702 is separated into four image frames, for example, by controller 220 (refer to FIG. 2), with each of the four image frames displaying only the image portion for one player, while the corresponding portions for other players are masked (or blackened). As a result, the color cycle rate (display rate) of image frames 710 needs to be at least four times the input image frame rate Rf, and will be 240 Hz if the input frame rate Rf is 60 Hz. In the exemplary embodiment as shown in FIG. 7, image frame 710₂ is displayed before image frame 710₃. In other embodiments, the display order of image frames 710₂ and 710₃ (or the other image frames for an input frame) may be reversed.

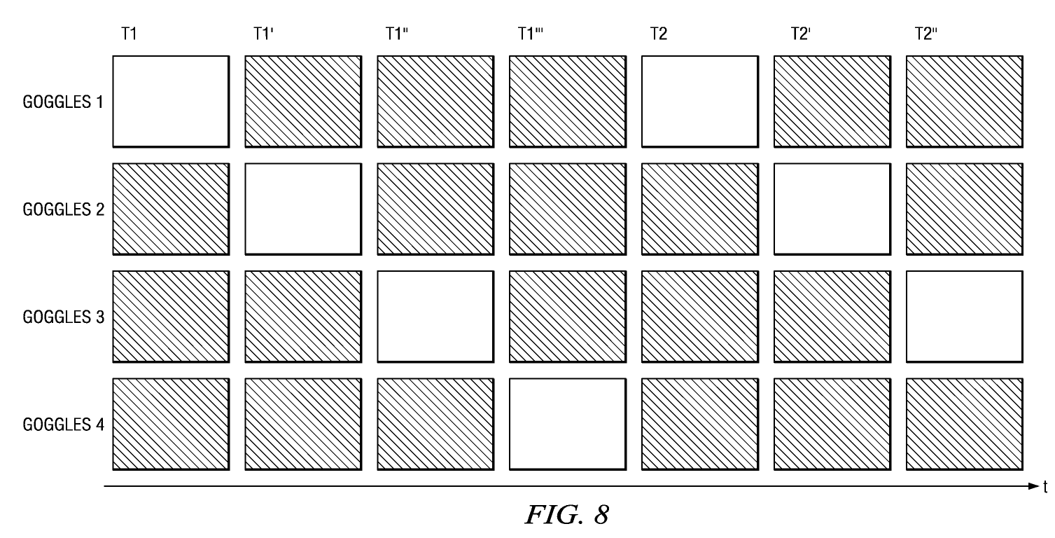

FIG. 8 illustrates the corresponding states of the goggles worn by players 1 through 4. Each of the goggles 1 through 4 will be turned on once with every four image frames in the second row of FIG. 7 displayed, and different goggles are turned on at different times. As a result, each of the players will only be able to see his/her own view. For example, player 1 will only see the view at the left top portion of display panel 215.

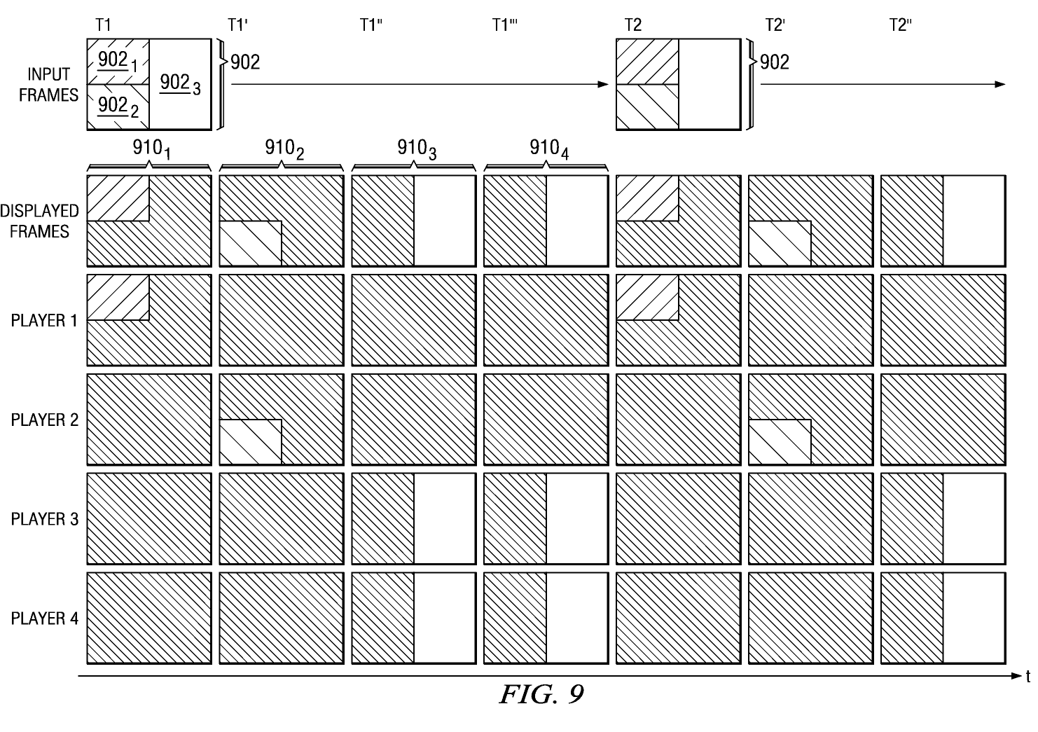

Advantageously, the views received by each of the players are determined by the timing of the states of view mechanisms 115. Therefore, players may be easily teamed together, with players in a same team receiving a same view. FIG. 9 illustrates an exemplary embodiment with four players, wherein players 1 and 2 form a group by themselves, while players 3 and 4 are teamed as a group. Input image frames 902 are divided into three portions, with portions 902₁ and 902₂ for players 1 and 2, and portion 902₃ for players 3 and 4. Correspondingly, display panel 215 will separate each input image frame 902 into four image frames 910, with images 910₃ and 910₄ being identical. By controlling goggles 3 and 4 to be turned on and off at the same time, players 3 and 4 may receive the same view. Alternatively, images 910₃ and 910₄ may be different, as shown in FIG. 7. However, since goggles 3 and 4 are both turned on at times T″ and T′″, players 3 and 4 may see their own views and their teammate's views.

The embodiments of the present application have several advantageous features. First, the embodiments of the present application are compatible with existing gaming systems that output top/bottom views or left/right views, which support the two-player mode at standard video display rates. Second, there is no requirement for game consoles to output image data at higher rates, and no requirement for game consoles to reformat the image data.

This solution allows a mixture of players and observers to see images clearly, with and without goggles. A strong player can be weakened by wearing goggles, while a weaker player may be strengthened by not wearing goggles. Observers without goggles may see both views without any artifacts. This is advantageous over other dual-view solutions, for example, with two full views of the players overlayed, since overlayed views are objectionable for others with no goggles.

Although the embodiments and their advantages have been described in detail, it should be understood that various changes, substitutions and alterations can be made herein without departing from the spirit and scope of the present application as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present application, processes, machines, manufacture, compositions of matter, means, methods, or steps, presently existing or later to be developed, that perform substantially the same function or achieve substantially the same result as the corresponding embodiments described herein may be utilized according to the present application. Accordingly, the appended claims are intended to include within their scope such processes, machines, manufacture, compositions of matter, means, methods, or steps.

What is claimed is:

1. A method for operating a multi-view display system, the method comprising:
receiving an image frame comprising a first portion and a second portion;
displaying a first image on a display panel during a first display period, wherein the first image comprises the first portion of the image frame, and wherein the second portion of the image frame is masked in the first image; and
after displaying the first image, displaying a second image on the display panel during a second display period, wherein the first image comprises the second portion of the image frame, and wherein the first portion of the image frame is masked in the second image, and wherein the first portion and the second portion of the image frame are displayed in different areas of the display panel.

2. The method of claim 1 further comprising providing synchronization signals for synchronizing with the first and the second display periods.

3. The method of claim 2 further comprising providing a first viewing device in response to the synchronization signals, wherein the first viewing device allows viewing of the first image and blocks viewing of the second image.

4. The method of claim 3 further comprising providing a second viewing device in response to the synchronization signals, wherein the second view device allows viewing of the second image and blocks viewing of the first image.

5. The method of claim 1 further comprising:
after displaying the second image, displaying a third image on the display panel during a third display period, wherein the third image comprises a third portion of the image frame, and wherein the first and the second portions and a fourth portion of the image frame are masked in the third image; and
after displaying the third image, displaying a fourth image on the display panel during a fourth display period, wherein the fourth image comprises the fourth portion of the image frame, and wherein the first, the second, and the third portions of the image frame are masked in the fourth image, and wherein the first, the second, the third, and the fourth display periods do not overlap.

6. The method of claim 1 further comprising:
after displaying the second image, displaying a third image on the display panel during a third display period, wherein the third image comprises a third portion of the image frame; and
after displaying the third image, displaying a fourth image identical to the third image on the display panel during a fourth display period, wherein the first and the second portions of the image frame are masked in the third and the fourth images, and wherein the first, the second, the third, and the fourth display periods do not overlap.

7. The method of claim 1 further comprising adjusting a boundary of the first portion in the first image, and a boundary of the second portion in the second image.

8. The method of claim 1, wherein each of the first and the second portions of the image frame comprises an array of pixels, and wherein the first and the second portions do not overlap.

9. A method for operating a multi-view display system, the method comprising:
receiving an image frame comprising a first portion and a second portion;
generating a first image comprising the first portion of the image frame, wherein the second portion of the image frame is masked in the first image; and
generating a second image comprising the second portion of the image frame, wherein the first portion of the image frame is masked in the second image, and wherein the first portion and the second portion of the image frame correspond to different areas of the display panel.

10. The method of claim 9 further comprising connecting a game console to the display system for providing the image frame, wherein each of the first and the second portions of the image frame is a view of a plurality of players.

11. The method of claim 9 further comprising:
displaying the first image at a first time; and
displaying the second image at a second time later than the first time by a half of a frame time of the image frame.

12. The method of claim 11 further comprising:
providing synchronization signals for synchronizing with the first and the second times; and
providing a first and a second viewing device in response to the synchronization signals, wherein the first viewing device allows viewing of the first image and blocks viewing of the second image, and wherein the second view device allows viewing of the second image and blocks viewing of the first image.

13. A display system comprising:
a display panel; and
a controller electrically coupled to the display panel, the controller being configured to:
receive an input image frame;
display a first image on the display panel during a first display period, wherein the first image comprises a first portion of the input image frame, and wherein a second portion of the input image frame is masked in the first image;
after displaying the first image, display a second image on the display panel during a second display period, wherein the second image comprises the second portion of the input image frame, and wherein the first portion of the input image frame is masked in the second image, and wherein the first and the second portions of the input image frames are displayed in different areas of the display panel; and
generate synchronization signals corresponding to the first and the second display periods.

14. The display system of claim 13 further comprising a signal dispatcher electrically coupled to the controller, the signal dispatcher being configured to dispatch the synchronization signals.

15. The display system of claim 14 further comprising a first viewing device signally coupled to the signal dispatcher and responsive to the synchronization signals, wherein the first viewing device allows viewing of the first image and blocks viewing of the second image.

16. The display system of claim 15 further comprising a second viewing device signally coupled to the signal dispatcher and responsive to the synchronization signals, wherein the second view device allows viewing of the second image and blocks viewing of the first image.

17. The display system of claim 13, wherein the first and the second images have a frame rate equal to multiple times of twice a frame rate of the input image frame.

18. The display system of claim 13, wherein the controller is further configured to:
after displaying the second image, display a third image on the display panel during a third display period, wherein the third image comprises a third portion of the input image frame, and wherein the first portion, the second portion, and a fourth portion of the input image frame are masked in the third image; and
after displaying the third image, display a fourth image on the display panel during a fourth display period, wherein the fourth image comprises the fourth portion of the input image frame, and wherein the first, the second, and the third portions of the input image frame are masked in the fourth image, and wherein the first, the second, the third, and the fourth display periods do not overlap.

19. The display system of claim 13, wherein each of the first and the second portions of the input image frame comprises an array of pixels, and wherein the first and the second portions do not overlap.

20. The display system of claim 13 further comprising a frame buffer electrically coupled to or embedded in the controller.
